(19) United States
(12) Patent Application Publication
(10) Pub. No.: US 2017/0072829 A1
(43) Pub. Date: Mar. 16, 2017

(54) Upper deck flat floors for fifth wheel RVs

(71) Applicants: Andrew Wade Cripe, Syracuse, IN (US); Barry Wade Ousley, Syracuse, IN (US)

(72) Inventors: Andrew Wade Cripe, Syracuse, IN (US); Barry Wade Ousley, Syracuse, IN (US)

(21) Appl. No.: 14/756,556

(22) Filed: Sep. 16, 2015

(51) Int. Cl. B60P 3/34

(52) U.S. Cl. CPC B60P 3/34

(57) ABSTRACT

A frame portion is provided for the upper deck of a fifth wheel travel trailer, wherein the side wall or perimeter beams are placed at the same elevation as the intermediate floor beams, preferably formed from the same dimension beams. Where additional reinforcing is needed along the frame perimeter, horizontally extending beams are used to supplement the side wall beams. Additional structure for receiving, resisting, absorbing, and/or reducing towing stresses, loads, and torques is formed in the forward portion of the upper deck, and can include a built up portion of the frame which is forward of the flat floor slide-out mechanism.

### BACKGROUND OF THE INVENTION

The present invention relates generally to recreational vehicles (“RVs”), and more particularly, to fifth wheels, a type of travel trailer. For additional background and definitional information on RVs, useful reference may be had to the definitions and explanations set forth by the Recreational Vehicle Industry Association (“RVIA”) at its internet web site, www.rvia.org.

Fifth wheel travel trailers are characterized by having a raised portion at the front of the trailer, often called the “upper deck” or platform. Most larger RVs, such as fifth wheels, are constructed to include or at least make available as a feature, one or more slide-out portions or rooms which expand the useful living area of the trailer when it is not being towed. These slide-outs can be placed in the walls of the main or lower deck, or in the walls of the upper deck. In general, there are slide-outs which result in a substantially “flat floor” when fully extended from the vehicle, or result in a stepped or raised floor when fully extended. A flat floor slide-out typically rests on top of the trailer floor when retracted into the trailer and then moves to a lower position when fully extended, wherein the floor portion of the slide-out is substantially flush with the floor of the adjacent portion of the trailer. A stepped floor slide-out, in contrast, maintains a significant and noticeable elevation between the floor of the slide-out and the floor of the adjacent portion of the trailer even when the slide-out is fully extended.

Flat floor slide outs have substantial advantages over stepped floor slide-outs in that they can provide more versatile floor space. For example, creating a flat floor interior of the trailer when the slide-out is fully extended permits the use of standard furniture in the slide-out area. In contrast, stepped floor slide-outs often use special or built in sofas or furniture to hide or cover the step area. An example of this is shown in U.S. Pat. No. 6,170,903. A flat floor slide-out can also avoid the need for an elevational step in the floor which impedes walking about the trailer. A flat floor slide-out can also simplify installation of a refrigerator or kitchen in the slide-out portion of the trailer. A flat floor slide-out also can provide an aesthetic advantage in, for example, giving the trailer the appearance of a more spacious interior. However, flat floor slide-outs can be more complicated to construct and more expensive to create and maintain. Further, flat floor slide-outs can impose different stresses on the frame of the trailer and/or require different modifications of the trailer frame.

Most RVs are presently constructed using a tubular frame as a base for the floors and walls mounted thereon. This frame also supports a device for connecting the trailer to the towing vehicle, typically through a hitch box at the front end of the frame. Towing of the trailer typically transmits forces, stresses, loads and torques, to the trailer frame through the hitch. These forces would tend to twist and deform the frame, and generally must be resisted in the frame design and construction. At the same time, the frame must be made economically and with as little weight as reasonably possible, in order to keep the RV costs down and to facilitate towing within reasonable vehicle fuel economies.

Fifth wheel frames have typically included side rail tubes and “center rails” or floor tubes intermediate the side rail tubes in both the lower or main portion of the frame and in the upper deck portion of the frame. However, in the lower portion of the frame the side rail tubes and the floor tubes often have the same or a “flush” vertical elevation. In the upper deck portion, the side rail tubes are typically larger than the floor tubes, providing greater rigidity and resistance to the towing forces and/or a sufficient build up to support the hitch receiving assembly or pin box of the trailer. For example, the upper deck side rail tubes may be formed from steel tubes with a six inch vertical dimension and a two inch horizontal dimension, referred to as a 6×2 tube. The floor tubes positioned between or intermediate those side rail tubes would instead typically be of 2×2 tubes. Various other arrangements of side rail tubes and floor tubes have also been used, but in general, the side rails, which form the perimeter of the trailer frame, are built up and result in a higher elevation as compared with the floor portion of the frame in the upper deck. An example of this is shown in U.S. Pat. No. 7,938,427.

At the same time, there are overall spacial constraints on fifth wheel trailers. The lower-most or bottom of the exterior of the upper deck portion must be high enough to go over the bed and hitch of the towing vehicle. However, the overall height of the top of the trailer or its roof, including any air conditioning units mounted thereon, are limited by vehicle codes and roadway obstruction standards. These spacial constraints generally limit the interior ceiling height of the upper deck portion, and prevent substantial build up over the floor tubes of the frame.

As a result of this difference in the frame between the upper deck and the main portion of the fifth wheel and as a result of the spacial constraints, the upper deck typically employs a noticeable cover over the enlarged side rail or beam and/or noticeable reduction in the ceiling height, as compared to the ceiling height of the main portion of the trailer. Further, as a result of the differential in the side rail tubes and floor tubes in the upper deck, there is typically insufficient room to allow the use of a flat floor slide-out. For example, the extra vertical elevation of the side rail would interfere unduly with slide-out movement and would result in a cross bar elevation over the floor at full extension of the slide out. Alternatively, the flat floor slide-out in the upper deck would require a substantial build up over the floor tubes in order to match the side rail tube elevation. That build up would noticeably decrease ceiling height, typically by three or more inches, rendering the overall upper deck portion less functional and/or aesthetically pleasing. Alternatively, merely reducing the side rail tube elevation instead to match the floor tube elevation would typically significantly reduce the structural integrity of the frame and thereby increase the risk frame damage during towing.

Accordingly, it is an object of the present invention to provide an improved fifth wheel travel trailer, particularly to allow the use of a flat floor slide-out in such trailers and to allow flooring to extend right to the side wall in the upper deck portion, avoiding a side rail cover or noticeable step at the wall-floor juncture. More specifically, the objects of the present invention include providing a fifth wheel travel trailer which:
a. has improved functionality and versatility,
b. is structurally reliable over time,
c. is economical to manufacture and maintain, and
d. is more readily adapted to a variety of uses.

### SUMMARY OF THE INVENTION

These and other objects of the present invention are obtained by the provision of a frame portion for the upper deck of a fifth wheel travel trailer wherein the side wall or perimeter beams are placed at the same elevation as the intermediate floor beams, preferably formed from the same dimension beams. Where additional reinforcing is needed along the frame perimeter, horizontally extending beams are used to supplement the side wall beams. Additional structure for receiving, resisting, absorbing, and/or reducing towing stresses, loads, and torques is formed in the forward portion of the upper deck, and can include a built up portion of the frame which is forward of the flat floor slide-out mechanism.

Other objects, advantages, and novel features of the present invention will become readily apparent from the following drawings and detailed description of preferred embodiments of this invention.

### BRIEF DESCRIPTION OF THE DRAWINGS

FIG. 1 is a rear, right, upper perspective view of partial construction of a fifth wheel travel trailer.

FIG. 2 is an enlarged view of the portion of FIG. 1 indicated at B therein.

FIG. 3 is an enlarged, right side view of the front portion of FIG. 1.

FIG. 4 is a further enlarged rear, top, right perspective view of the upper deck portion of FIG. 1.

FIG. 5 is an enlarged, top view of the front portion of FIG. 1.

FIG. 6 is an enlarged rear view of the upper deck portion of FIG. 1.

FIG. 7 is a further enlarged view of the portion of FIG. 6 indicated at A therein.

FIG. 8 is a rear, right, upper perspective view of a the trailer of FIG. 1 with upper deck flooring in place.

FIG. 9 is an enlarged view of the portion of FIG. 8 at C therein.

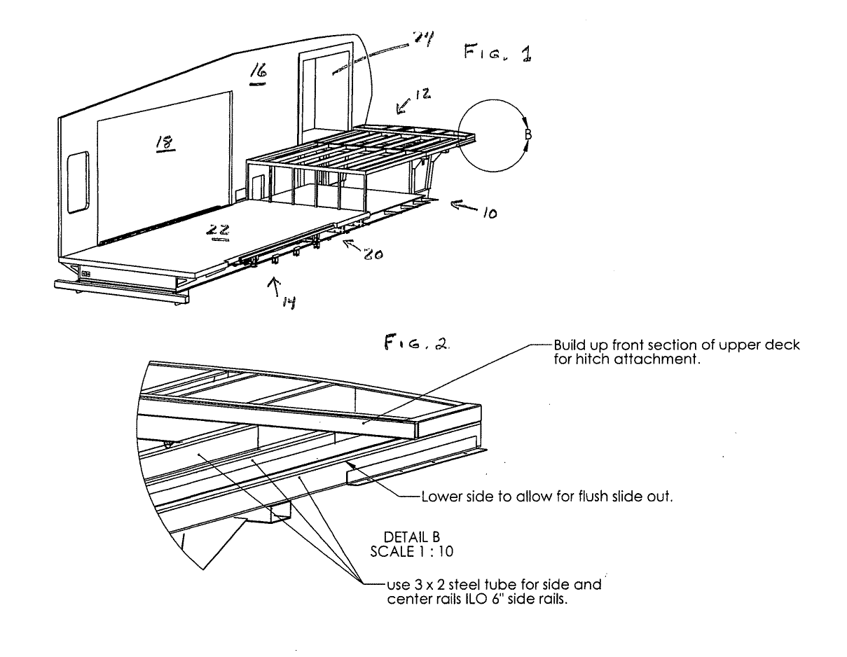

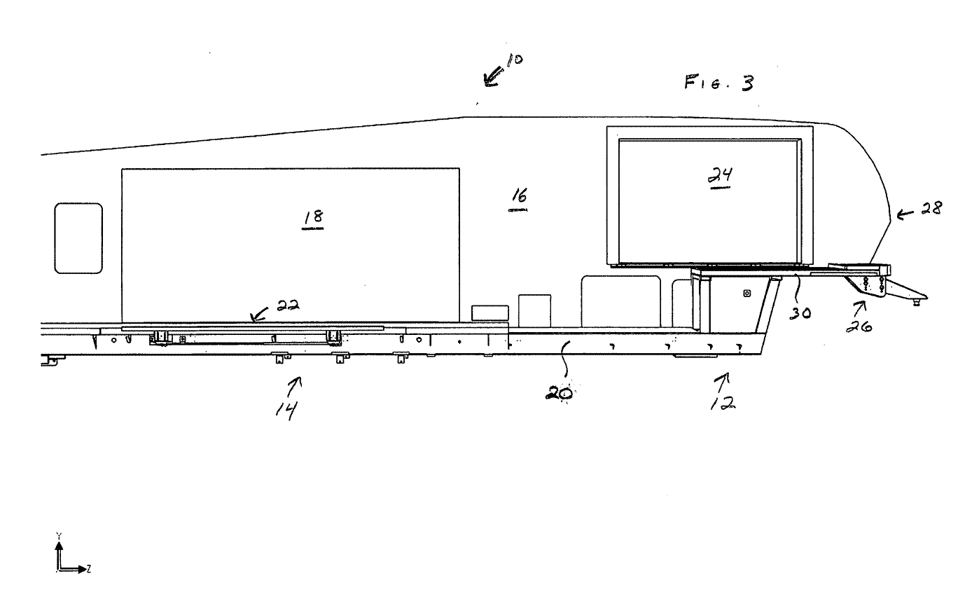

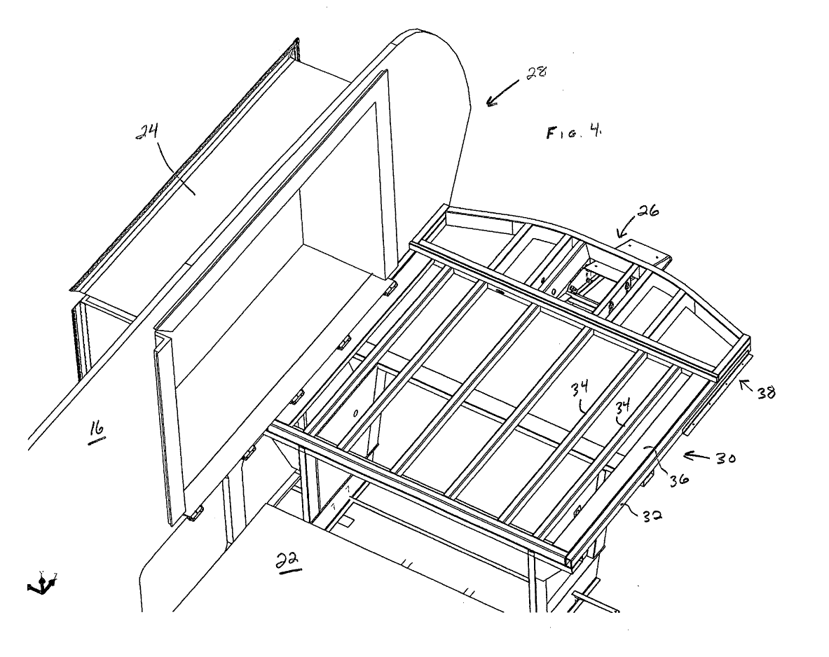

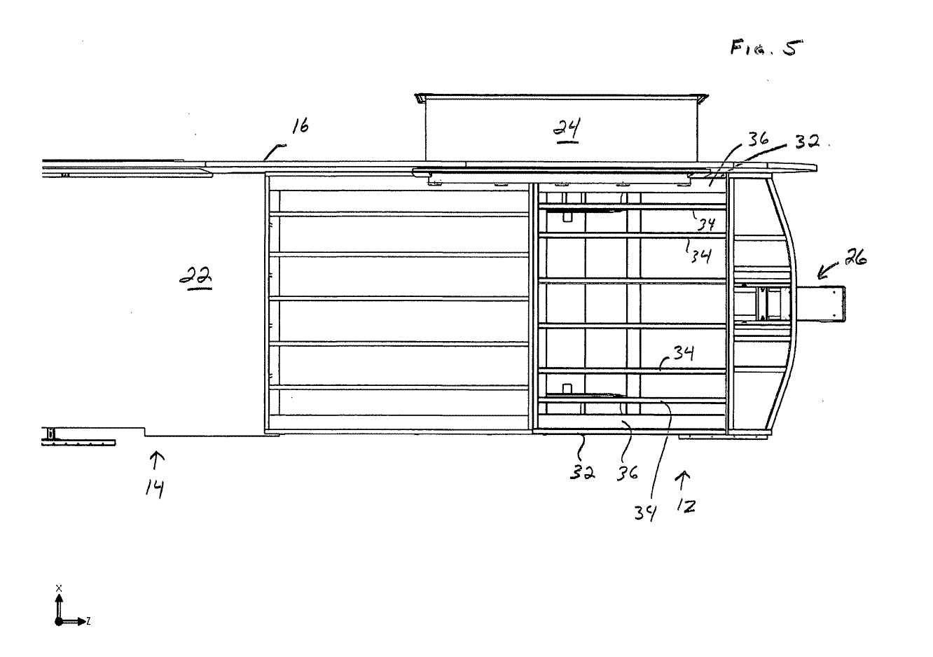

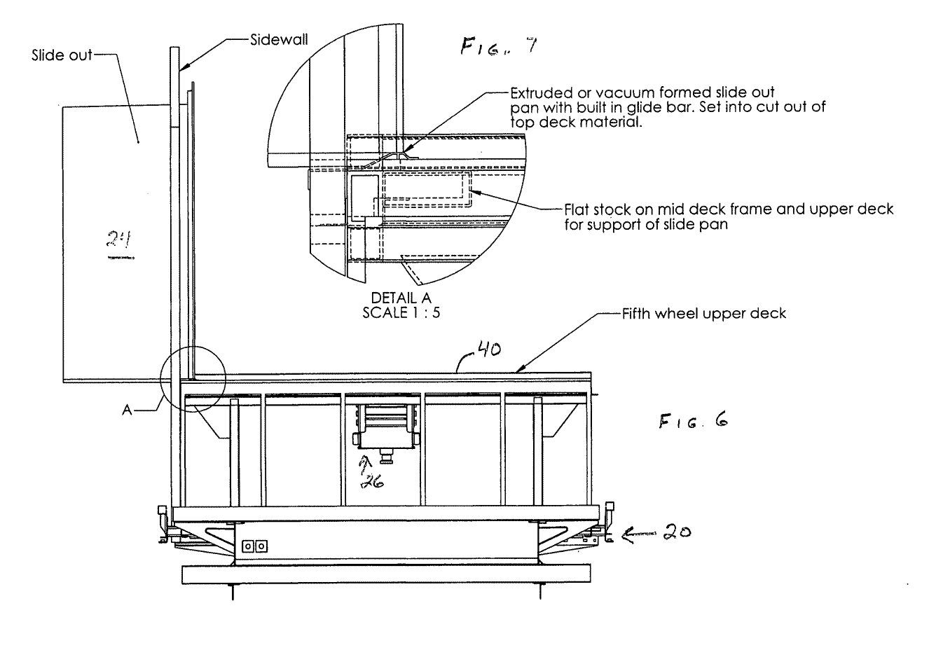

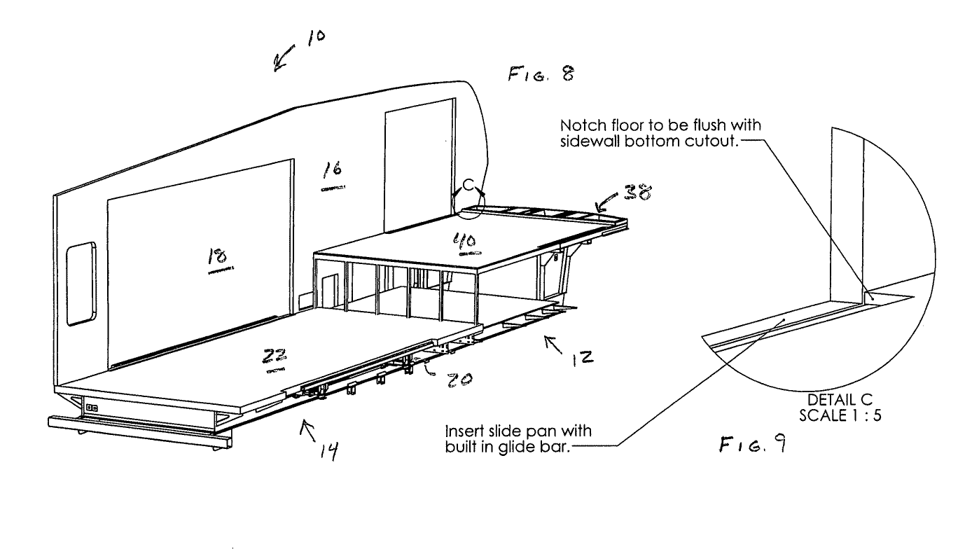

### DETAILED DESCRIPTION OF PREFERRED EMBODIMENTS

The figures show a preferred embodiment of the present invention and explain preferred features of that frame structure. As used herein, the term “beam” refers to the structural elements used in the frame construction of the fifth wheel. As will be understood by those of skill in the art, the beam can be a rail, tube, C-channel, or I beam, as is appropriate in a given application, according to conventional standards for structural integrity, cost, and weight concerns. The flooring can be of conventional construction as well, utilizing plywood, OSB, various laminate sheathing or like material covered by carpet, tile or other materials.

The following features are enumerated in the figures:

10—the fifth wheel trailer

12—the upper deck portion of the fifth wheel trailer

14—the main deck portion of the fifth wheel trailer

16—the left wall of the fifth wheel trailer

18—the slide-out opening for the main deck portion

20—the fifth wheel frame

22—the main deck floor

24—the upper deck slide-out portion

26—the hitch connection assembly or pin box

28—the front of the fifth wheel trailer

30—the upper deck frame

32—a side rail frame beam

34—an intermediate floor beam

36—a side rail support beam

38—the built up portion of the upper deck frame

40—the upper deck floor

With the present invention, the side rail frame beam 32 for the upper deck portion does not extend vertically higher than the top surface or height of the intermediate frame beam 34. Thus, when the upper deck floor 40 is mounted to the upper deck frame, the upper deck slide-out portion can slide horizontally over the upper deck floor from without obstruction, from a closed position to an extended position, using substantially the conventional practices and/or structures as typically found with flat floor slide-outs used on the main deck floor. This upper deck frame structure is accomplished, for example, in preferred embodiments of the present invention by using 3×2 steel tubes for both elements 32 and 34. Further, this arrangement allows upper deck floor 40 to extend completely across the upper deck and abut flush against the side walls of the trailer. At the same time, since the upper deck floor rests at the height of the center rails or intermediate floor beams, without any additional build up to match additional height cause by the side rail beams, the maximum floor height to the ceiling is available. Thus, maximum user headroom is not adversely affected.

In order to maintain the overall structural rigidity of the fifth wheel frame and prevent towing stresses, loads, and torques from adversely affecting the fifth wheel trailer, the present invention provides additional improvements for use alternatively or in tandem. First, rather than using vertically extending beams along the perimeter of the frame, horizontally extending side rail support beams 36 are disposed adjacent and/or connected to the side rail frame beams of the upper deck frame. This connection can be made by a variety of conventional means, such as welding. The side rail support beams are, for example, disposed interiorly of the side rail frame beams, toward the intermediate floor beams, and the top surface of these support beams does not extend vertically higher than the top surface or height of the intermediate frame beam 34.

In addition, the upper deck frame may include structural means toward the front of the travel trailer for directly receiving, resisting, absorbing, and or reducing the towing forces which cause deformation stresses, loads, and/or torques. For example, a built up portion 38 of the upper deck frame can be formed forwardly of the path used by the upper deck slide-out portion. This built up portion may be formed with perimeter side rails which extend vertically higher than the top surface or height of the intermediate frame beam 34, but due to their location do not interfere with the operation of the slide-out portion. This built up portion may for the base for closets, cabinetry and/or utility space at the front of the upper deck, and, thus, not adversely affect usable interior headroom. At the same time, such an arrangement would not interfere with the user's ability to freely walk about the upper deck portion or to position normal furnishing where they could otherwise be placed.

In the preferred embodiment shown in the drawings, both of these structural reinforcement features are employed. Various other alternative structures can be employed as well in a given application, such as devices mounted in or constructed integral with the pin box, according to the needs and circumstances of the towing vehicle, trailer loads, costs of manufacture, and usual other considerations.

While the present invention has been illustrated and described above with respect to particular embodiments and alternatives, that is done only by way of illustration and example. In light of this disclosure, it will be evident to those of skill in the art that various other embodiments are encompassed in these inventive concepts. Accordingly, the spirit and scope of this invention are only limited by the following claims.

What is claimed is:

1. A fifth wheel travel trailer having and flat floor slide-out within its upper deck.

2. A fifth wheel travel trailer having a frame with an upper deck portion formed from horizontally extending side beams at the frame perimeter and intermediate center beams, the vertical height of the side beams being no greater than that of the center beams, and a slide out assembly being mounted in the upper deck which allows for flat floor positioning in the extended position of the slide-out.

3. The fifth wheel travel trailer according to claim 2 wherein perimeter reinforcement of the upper deck portion of the frame is provided by horizontally extending support beams adjacent to and interior of the side beams along the frame perimeter.

4. The fifth wheel travel trailer according to claim 2 wherein the frame includes a structural device forward of the operation of the upper deck slide-out portion for directly receiving, resisting, absorbing, and or reducing the towing forces which cause deformation stresses, loads, and/or torques.

5. The fifth wheel travel trailer according to claim 3 wherein the frame includes a structural device forward of the operation of the upper deck slide-out portion for directly receiving, resisting, absorbing, and or reducing the towing forces which cause deformation stresses, loads, and/or torques.
